(19) United States
(12) Patent Application Publication
(10) Pub. No.: US 2023/0164708 A1
(43) Pub. Date: May 25, 2023

(54) CHANNEL LEARNING AND POWER TRANSMISSION IN WIRELESS POWER NETWORKS

(71) Applicant: TRANSFERFI PTE. LTD., Singapore (SG)

(72) Inventors: Mohammad Reza VEDADY MOGHADAM NANEHKARAN, Singapore (SG); Jie XU, Shenzhen (CN); Ganggang MA, Guangzhou (CN)

(73) Assignee: TRANSFERFI PTE. LTD., Singapore (SG)

(21) Appl. No.: 17/917,065

(22) PCT Filed: Apr. 5, 2021
(86) PCT No.: PCT/CN2021/085517

§ 371 Date: Oct. 5, 2022

(30) Foreign Application Priority Data
Apr. 5, 2020 (SG) 10202003146T

(51) Int. Cl. H04W 52/36; H02J 50/40; H02J 50/80; H02J 50/20; H04L 5/00; H04B 7/06

(52) U.S. Cl. CPC H04W 52/367; H02J 50/402; H02J 50/80; H02J 50/20; H04L 5/0048; H04B 7/0621

(57) ABSTRACT

The present disclosure relates to channel learning and power transmission in wireless power networks. A method of estimating channels between a transmitter and a plurality of receivers in a wireless power network is described. The transmitter comprises an array of wireless power transmission antennas. The method comprises: transmitting a pilot signal from the wireless power transmission antennas of the transmitter; receiving feedback signals from each receiver of the plurality of receivers, the feedback signals comprising received signal power indications for each respective receiver; calculate channel matrices for channels between the wireless transmission antennas and wireless power reception antennas of each respective receiver by minimizing an objective function of a channel matrix and the received signal power indications for the respective receiver; and estimating spatial channel signatures of the reception antennas on the array of wireless power transmission antennas from the dominant eigenvalue and corresponding eigenvector of the respective channel matrix.

### TECHNICAL FIELD

The present disclosure relates to wireless power transmission and in particular to channel learning and power transmission in wireless power networks.

### BACKGROUND

Wireless power networks typically comprise a wireless power transmitter and a plurality of wireless power receivers. The wireless power transmitter transmits power to the receivers which is used to charge an energy storage device on the wireless power receivers. In order to efficiently transmit wireless power to the wireless power receivers, the wireless power transmitter must determine spatial channels between antennas of the transmitter and antennas of the wireless power receivers.

### SUMMARY

According to a first aspect of the present disclosure, a method of learning channels between a transmitter and a plurality of receivers in a wireless power network is provided. The transmitter comprises an array of wireless power transmission antennas, the method comprises: transmitting a pilot signal from the wireless power transmission antennas of the transmitter; receiving feedback signals from each receiver of the plurality of receivers, the feedback signals comprising received signal power indications for each respective receiver; deriving channel matrices for channels between the wireless transmission antennas and wireless power reception antennas of the respective receivers by minimizing an objective function of the channel matrix and the received signal power indications for each respective receiver; and estimating spatial channel signatures between the wireless transmission antennas and wireless power reception antennas of each respective receiver from the dominant eigenvalue and corresponding eigenvector of its channel matrix.

In embodiments of the present invention, the use of the sum squared error (or the sum squared difference) enables the derivation of a closed form solution for the channel learning problem. This reduces the computational complexity and allows practical implementation. Further, the proposed channel learning problem can be scaled over the number of receivers without the need for extra training pilot signals.

In an embodiment, the objective function is the sum squared difference between the estimated power delivered to each respective receiver calculated using its channel matrix and the received signal power indications for the same receiver.

According to a second aspect of the present disclosure, a wireless power transmission method in a wireless power network, the wireless power network comprising a wireless power transmitter and a plurality of wireless power receivers, the wireless power transmitter comprising an array of wireless power transmission antennas and each wireless receiver of the plurality of wireless power receiver comprising a wireless power reception antenna, the method comprising: estimate spatial channels between the array of wireless power transmission antennas and the wireless power reception antennas of the plurality of wireless power receivers; dividing a wireless power transmission time into a plurality of timeslots, wherein each timeslot is allocated to a respective one of the wireless power receivers; and in each timeslot of the plurality of timeslots, transmitting power from the array of wireless power transmission antennas according to a transmitter signal vector that maximizes the delivered power to the wireless power receiver to which the timeslot is allocated.

In an embodiment, the amplitude of the power transmitted from the array of wireless power transmission antennas is modified according to a total power transmission constraint.

In an embodiment, each timeslot has an equal duration.

In an embodiment, the method further comprises optimizing the duration of each respective timeslot.

According to a third aspect of the present disclosure, a wireless power transmission method in a wireless power network is provided. The wireless power network comprises a wireless power transmitter and a plurality of wireless power receivers, the wireless power transmitter comprises an array of wireless power transmission antennas and each wireless receiver of the plurality of wireless power receivers comprises a wireless power reception antenna. The method comprises: estimating spatial channels between the array of wireless power transmission antennas and the wireless power reception antennas of the plurality of wireless power receivers; and dividing a wireless power transmission time into a plurality of timeslots; and in each timeslot of the plurality of timeslots, transmitting power from the array of wireless power transmission antennas according to a transmitter signal vector, wherein the duration of respective timeslots is optimized according to a target constraint on the power delivered to each respective antenna over the plurality of timeslots.

In an embodiment, the spatial channels between the array of wireless power transmission antennas and the wireless power reception antennas of the plurality of wireless power receivers are obtained according to a method set out above.

According to a fourth aspect of the present disclosure a wireless power transmission method in a wireless power network is provided. The wireless power network comprises a wireless power transmitter and a plurality of wireless power receivers, the wireless power transmitter comprises an array of wireless power transmission antennas and each wireless receiver of the plurality of wireless power receivers comprises a wireless power reception antenna. The method comprises: transmitting wireless power from the array of wireless power transmission antennas; receiving an indication from a wireless receiver of the plurality of wireless power receivers, the indication indicating a signal power received by the wireless receiver during the wireless power transmission; comparing the signal power received by the wireless receiver during the wireless power transmission with a signal power received by the wireless receiver during a previous frame of wireless power transmission to determine a drop in signal power received by the wireless receiver; and if the drop in signal power received by the wireless receiver exceeds a threshold initiating a channel learning sequence in a succeeding frame of wireless power transmission.

In an embodiment, the method further comprises determining a number of pilot signals for the channel learning sequence based on the drop in signal power received by the wireless receiver.

In an embodiment, the spatial channels between the array of wireless power transmission antennas and the wireless power reception antennas of the plurality of wireless power receivers are estimated according to a method set out above.

According to a fifth aspect of the present disclosure, a controller for a wireless power transmitter configured to cause the wireless power transmitter to carry out a method as set out above is provided.

According to a sixth aspect of the present disclosure, a computer readable carrier medium carrying processor executable instructions which when executed on a processor cause the processor to carry out a method a method as set out above is provided.

According to a seventh aspect of the present disclosure a wireless power transmitter comprising an array of wireless power transmission antennas and a controller is provided. The controller is configured to: control the transmission antennas to transmit a pilot signal; receive feedback signals from each receiver of a plurality of receivers, the feedback signals comprising received signal power indications for each respective receiver; derive channel matrices for channels between the wireless transmission antennas and wireless power reception antennas of the respective receivers by minimizing an objective function of the channel matrix and the received signal power indications for each respective receiver; and estimate spatial channel signatures between the wireless transmission antennas and wireless power reception antennas of each respective receiver from the dominant eigenvalue and corresponding eigenvector of its channel matrix.

In an embodiment, the objective function is the sum squared difference between the approximate power delivered to each respective receiver calculated using its channel matrix and the received signal power indications for the same receiver.

According to an eighth aspect of the present disclosure a wireless power transmitter comprising an array of wireless power transmission antennas and a controller is provided. The controller is configured to: estimate spatial channels between the array of wireless power transmission antennas and the wireless power reception antennas of a plurality of wireless power receivers; divide a wireless power transmission time into a plurality of timeslots, wherein each timeslot is allocated to a respective one of the wireless power receivers; in each timeslot of the plurality of timeslots, control the array of wireless power transmission antennas to transmit power according to a transmitter signal vector that maximizes the delivered power to the wireless power receiver to which the timeslot is allocated.

In an embodiment, the controller is configured to control the amplitude of the power transmitted from the array of wireless power transmission antennas according to a total power transmission constraint, hi an embodiment, each timeslot has an equal duration.

In an embodiment, the controller is further configured to optimize the duration of each respective timeslot.

According to a ninth aspect of the present disclosure, a wireless power transmitter comprising an array of wireless power transmission antennas and a controller is provided. The controller is configured to: estimate spatial channels between the array of wireless power transmission antennas and wireless power reception antennas of a plurality of wireless power receivers; divide a wireless power transmission time into a plurality of timeslots; and in each timeslot of the plurality of timeslots, transmitting power from the array of wireless power transmission antennas according to a transmitter signal vector, wherein the duration of respective timeslots is optimized according to a target constraint on the power delivered to each respective antenna over the plurality of timeslots.

In an embodiment, the controller is further configured to: control the transmission antennas to transmit a pilot signal; receive feedback signals from each receiver of a plurality of receivers, the feedback signals comprising received signal power indications for each respective receiver; derive channel matrices for channels between the wireless transmission antennas and wireless power reception antennas of the respective receivers by minimizing an objective function of the channel matrix and the received signal power indications for each respective receiver; and estimate spatial channel signatures between the wireless transmission antennas and wireless power reception antennas of each respective receiver from the dominant eigenvalue and corresponding eigenvector of its channel matrix.

According to a tenth aspect of the present disclosure, a wireless power transmitter comprising an array of wireless power transmission antennas and a controller is provided. The controller is configured to: control the array of wireless power transmission antennas to transmit wireless power; receive an indication from a wireless receiver of a plurality of wireless power receivers, the indication indicating a signal power received by the wireless receiver during the wireless power transmission; compare the signal power received by the wireless receiver during the wireless power transmission with a signal power received by the wireless receiver during a previous frame of wireless power transmission to determine a drop in signal power received by the wireless receiver; and if the drop in signal power received by the wireless receiver exceeds a threshold initiate a channel learning sequence in a succeeding frame of wireless power transmission.

In an embodiment, the controller is further configured to determine a number of pilot signals for the channel learning sequence based on the drop in signal power received by the wireless receiver.

In an embodiment, the controller is further configured to: control the transmission antennas to transmit pilot signals; receive feedback signals from each receiver of a plurality of receivers, the feedback signals comprising received signal power indications for each respective receiver; derive channel matrices for channels between the wireless transmission antennas and wireless power reception antennas of the respective receivers by minimizing an objective function of the channel matrix and the received signal power indications for each respective receiver; and estimate spatial channel signatures between the wireless transmission antennas and wireless power reception antennas of each respective receiver from the dominant eigenvalue and corresponding eigenvector of its channel matrix.

### BRIEF DESCRIPTION OF THE DRAWINGS

In the following, embodiments of the present invention will be described as non-limiting examples with reference to the accompanying drawings in which:

FIG. 1 is a block diagram showing a wireless power transmission network according to an embodiment of the present invention;

FIG. 2 shows a channel model and feedback system of a wireless power transmission network according to an embodiment of the present invention;

FIG. 3 shows a frame structure of wireless power transmission according to an embodiment of the present invention;

FIG. 4 is a flow chart showing a method of estimating channels between a transmitter and a plurality of receivers in a wireless power network according to an embodiment of the present invention;

FIG. 5 is a flow chart showing a method of wireless power transmission according an embodiment of the present invention;

FIG. 6 shows the timing structure of an energy transmission phase of wireless power transmission according to an embodiment of the present invention;

FIG. 7 is a block diagram illustrating split beam wireless power transmission according to an embodiment of the present invention;

FIG. 8 is a flow chart showing a method of split beam wireless power transmission according to an embodiment of the present invention;

FIG. 9 shows the timing structure of an energy transmission phase of split beam wireless power transmission according to an embodiment of the present invention; and

FIG. 10 is a flow chart showing a method of adapting pilot sequence transmission according to an embodiment of the present invention.

### DETAILED DESCRIPTION

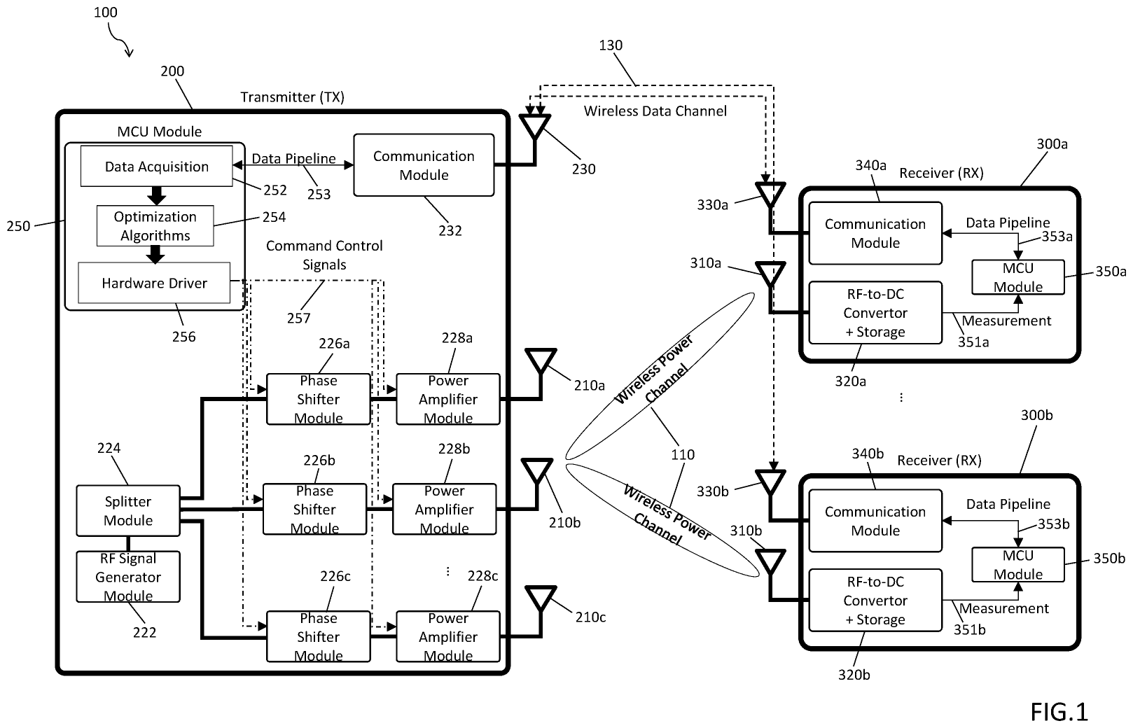

FIG. 1 is a block diagram showing a wireless power transmission network according to an embodiment of the present invention. The wireless power network 100 comprises a wireless power transmitter 200 and a plurality of wireless power receivers 300a 300b. The wireless power transmitter 200 comprises a plurality of transmitter antennas 210a 210b 210c which can be controlled by the wireless power transmitter 200 to transmit power over one or more wireless power transmission frequency bands. The transmitter antennas 210a 210b 210c may be arranged in a centralized manner or a distributed manner. The power transmission frequency bands may comprise conventional RF bands including 433 MHz, 915 MHz, 2.4 GHz, 5.8 GHz, or millimeter-wave bands including 26, 28, 38, and 60 GHz. Each of the wireless power receivers 300a 300b comprises a receiver antenna 310a 310b. Wireless power channels 110 may be defined between the transmitter antennas 210a 210b 210c of the wireless power transmitter 200 and the receiver antennas 310a 310b of the respective wireless power receivers 310a 310b.

Each of the wireless power receivers 300a 300b comprises an RF-to-DC converter and storage 320a 320b which converts the wireless power received from the wireless power transmitter 200 into direct current and uses the received power to charge an energy storage device such as a battery, a capacitor or a supercapacitor. Each of the wireless power receivers 300a 300b further comprises a microcontroller unit (MCU) module 350a 350b and a communication module 340a 340b. The MCU module 350a 350b receives measurement data 351a 351b from the RF-to-DC converter and storage 320a 320b which indicates the wireless power received by the wireless power receiver 300a 300b over the wireless power channels 110. The measurement data 351a 351b may also comprise indications of the charge stored in the energy storage device of the wireless power receiver 300a 300b. The MCU module 350a 350b is coupled to the communication module 340a 340b by a data pipeline 353a 353b which transfers data generated by the MCU module 350a 350b to communication module 340a 340b. The communication module 340a 340b is coupled to a data transmission antenna 330a 330b which allows data communication over a wireless data channel 130 with the wireless power transmitter 200.

The wireless data channel 130 may be Bluetooth channel to carry signals according to the Bluetooth standard. Alternatively, wireless data channel 130 may be configured to carry signals according to the ZigBee, LoRa, WiFi, or Narrowband IoT (NB-IoT) communication protocols. Thus, the communication module 340a 340b of the wireless power receiver 300a 300b may be a Bluetooth module or alternatively a ZigBee, LoRa, WiFi, or Narrowband IoT (NB-IoT) communication module.

In some embodiments, each of the wireless power receivers 300a 300b may comprise a single antenna for both power reception and data transmission. In such embodiments, the wireless power receivers 300a 300b further comprise an RF switch configured to switch the combined antenna between different circuitries.

The wireless power transmitter 200 comprises a data communication antenna 230 which is coupled to a communication module 232. The data communication antenna 230 and communication module 232 are configured to send and receive signals over the wireless data channel 130 and thus are configured to operate according to a Bluetooth wireless standard or other wireless standard as mentioned above. The wireless power transmitter 200 further comprises an RF signal generator module 222 which generates RF signals for transmission from the wireless power transmitter 200 to the wireless power receivers 300a 300b. The RF signal generator module 222 is coupled to a splitter module 224 which splits the RF signal into a plurality of signals each for transmission from a respective transmitter antenna 210a 210b 210c. Each signal path from the splitter module 224 to a respective transmitter antenna 210a 210b 210c comprises a phase shifter module 226a 226b 226c power amplifier module 228a 228b 228c which allow the phase and amplitude of the wireless signals transmitted from the transmitter antennas 210a 210b 210c to be individually controlled.

The wireless power transmitter 200 comprises a microcontroller unit (MCU) module 250. The MCU module 250 comprises a data acquisition module 252, optimization algorithms 254 and a hardware driver 256. The data acquisition module 252 is coupled to the communications module 232 by a data pipeline 253. Thus, the MCU module 252 can receive data over the wireless data channel 130. The hardware driver 256 generates command control signals 257 which control the phase shifter modules 226a 226b 226c and the power amplifier modules 228a 228b 228c. Thus, the MCU module 250 can control the phase and amplitude of signals transmitted by the transmitter antennas 210a 210b 210c of the wireless power transmitter.

Embodiments of the present invention relate to how the MCU module 250 of the wireless power transmitter 200 determines channel signatures of the wireless power channels 110 between the transmitter antennas 210a 210b 210c and the receiver antennas 310a 310b based on feedback signals received over the wireless data channel 130 indicating signal strengths of received pilot signals. Further embodiments of the present disclosure relate to how the MCU module 250 of the wireless power transmitter 200 controls wireless power transmission to the wireless power receivers 300a 300b.

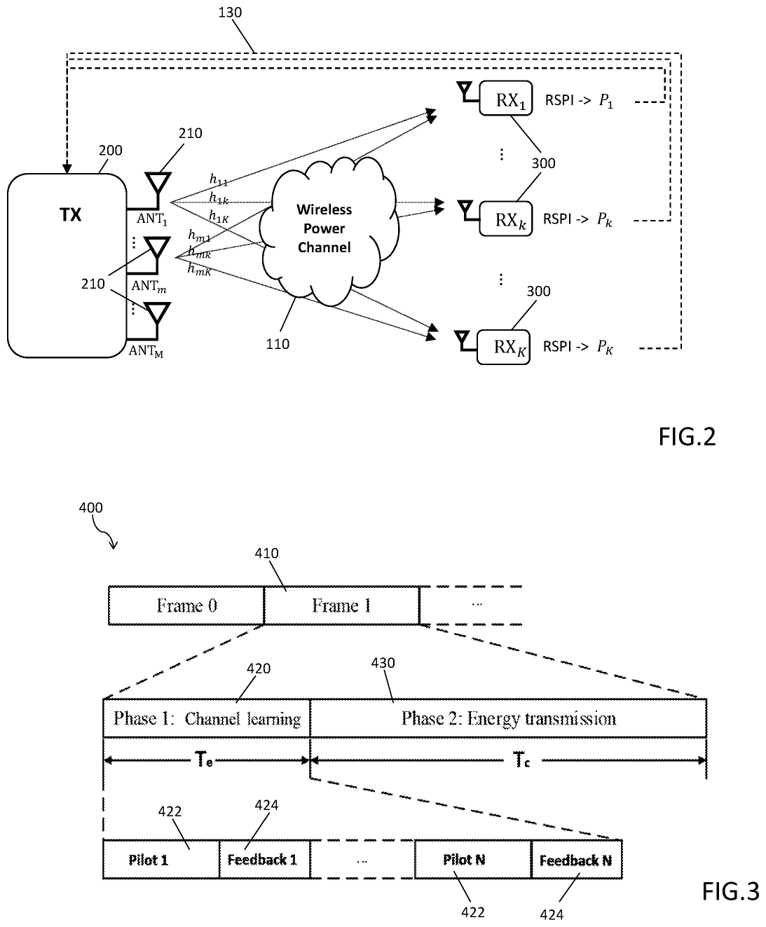

FIG. 2 shows a channel model and feedback system of a wireless power transmission network according to an embodiment of the present invention. As shown in FIG. 2, the wireless power transmitter 200 has M>1 antennas 210, indexed by m and the wireless power network comprises K≥1 wireless power receivers 300, indexed by k. The wireless power channel 110 can be modelled a vector for each wireless power receiver 300. The wireless power channel vector for receiver k is modeled by hₖ=[h₁ₖ . . . hₘₖ]^{T}, where hₘₖ's are complex values. In the rest of this disclosure, term “channel” is used to refer to “wireless power channel”. For a certain time period (so-called, channel coherence time), the values hₘₖ are assumed to be fixed.

The channel matrix for each receiver k is defined as:

Hₖ=hₖ k^{H}ₖ′

with k^{H}ₖ denoting the Hermitian transpose of hₖ. So, it follows that rank(Hₖ)=1, and Hₖ [symbol] 0 i.e. a positive semidefinite (PSD) matrix.

The received signal power indication (RSPI) of receiver k, i.e., Pₖ, represents the RF power received at its antenna. The wireless power receiver 300 sends this value to the wireless power transmitter 200 via the wireless data channel 130.

FIG. 3 shows a frame structure of wireless power transmission according to an embodiment of the present invention. As shown in FIG. 3, the wireless power transmission 400 comprises is plurality of frames 410. A frame 410 comprises a channel learning phase 420 and an energy transmission phase 430. The channel learning phase 410 is denoted as Tₑ and the energy transmission phase is denoted as T_{c}. In the channel learning phase 420, pilot signals are transmitted from the wireless power transmitter 200 to each of the wireless power receivers 300 and feedback is sent by the wireless power receivers 300 to the wireless power transmitter 200. N≥1 pilots are used for channel learning. Each pilot is realized by setting different values for the phase shifter module the gain of amplifier module corresponding to each transmitter antenna 210. For the n^{th} pilot, the transmit signal vector and matrix are represented as sₙ and Sₙ, respectively. Also, the corresponding RSPI feedback from the kth receiver is denoted by P_{k,n}.

The pilots are either randomly generated, or following a pre-defined sequence of numbers. Also, the previous/outdated channel information may be used to generate random pilot signals around them. After sending each pilot, the transmitter waits to receive the RSPI feedback from all receivers. All values are then saved for the channel calculation/learning. Some delay is provided between pilot transmission to ensure the accuracy of RSPI feedback. Delay should be larger than the receiver data transmission rate. For example, if the receiver data transmission rate is 2 KHz, 1 milli-second delay is sufficient.

A channel learning algorithm is implemented on the MCU module 250 of the wireless power transmitter 200. The channel learning algorithm runs at the beginning of each frame (e.g. every 10 seconds) or when needed.

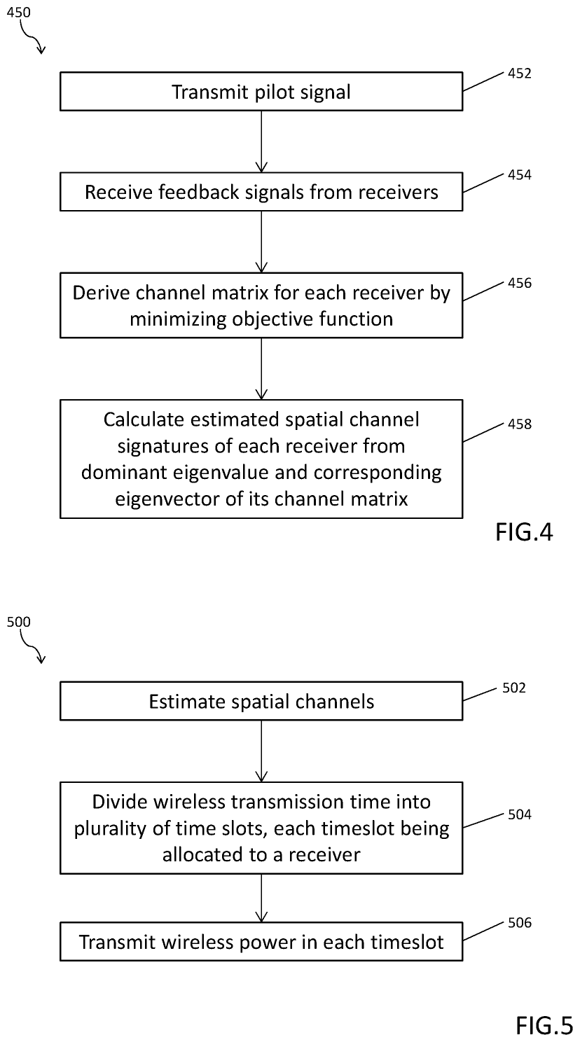

FIG. 4 is a flow chart showing a method of estimating channels between a transmitter and a plurality of receivers in a wireless power network according to an embodiment of the present invention. The method 450 shown in FIG. 4 is carried out by the wireless power transmitter 200 shown in FIG. 1 and FIG. 2.

In step 452, the transmitter antennas 210 of the wireless power transmitter 200 transmit a pilot signal to the wireless power receivers 300. The pilot signal is received by the wireless power receivers 300. The wireless power receivers determine a received signal power indication (RSPI) and send feedback signals to the wireless power transmitter 200 over the wireless data channel 130.

In step 454, the feedback signals are received by the communication module 232 of the wireless power transmitter 200. These signals are then transferred to the MCU module 250 over the data pipeline 253.

In step 456, the MCU module 250 of the wireless power transmitter calculates the channel matrix of each receiver by minimizing an objective function of the channel matrix and the received signal power indications for each respective receiver. Once all pilot transmission is completed, the channel matrix of kth receiver is derived by solving the following problem:

$$( P 1 - k ) : {min}_{{H}_{k}} {\sum }_{n = 1}^{N} {\vert tr ( {S}_{n} {H}_{k} ) - {P}_{k , n} \vert}^{2}$$

$$s . t . {H}_{k} ≽ 0 \& rank ( {H}_{k} ) = 1 .$$

By removing the rank-one constraint in (P1-k), the resulting relaxed problem is convex. The optimal solution to the relaxed (P1-k) is denoted by Wₖ, which is derived using e.g. a sub-gradient method or the closed-form solution given below. Two cases then follow:

Case 1) If rank(H*ₖ)=1, apply the Eigenvalue Decomposition (EVD) to H^{*}ₖ. Denote λₘₐₓ and vₘₐₓ as the dominant eigenvalue and its corresponding eigenvector H^{*}ₖ, respectively. Then, it follows hₖ=|\sqrt{λₘₐₓ|}vₘₐₓ.

Case 2) If rank(H^{*}ₖ)>1, a sub-optimal solution is given by hₖ=\sqrt{|λₘₐₓ|}vₘₐₓ.

The above procedure is repeated for all receivers one by one, or concurrently using parallel computation techniques.

In step 458, the MCU module 250 of the wireless power transmitter estimates the spatial channel signatures of the reception antennas on the array of wireless power transmission antennas from the dominant eigenvalue and corresponding eigenvector of the channel matrix.

A closed form solution to the channel learning problem is as follows.

Denote the m-th column of matric Wₖ^{m*} and S, as Hₖ^{m*} and Sₙ^{m}, respectively.

Define

$${a}_{n} = {[ \begin{matrix}{S}_{n}^{{1}^{T}} & … & {S}_{n}^{{M}^{T}}\end{matrix} ]}^{T} and {b}_{k} = [ \begin{matrix}\begin{matrix}{H}_{k}^{1 {*}^{T}} & …\end{matrix} & {{H}_{k}^{M {*}^{T}} ]}^{T}\end{matrix} ,$$

where the size of each vector is M²×1. Also, define Pₖ=[P_{k,1} . . . P_{k,N}]^{T}.

If N≥M²: “unique solution” is bₖ=(AA^{H}) A Pₖ, where A=[a₁ . . . a_{N}] and (.)^{t} is Moore-Penrose pseudoinverse operator. Reconstruct H^{*}ₖ using the obtained bₖ. Use either Case 1 or 2 to find hₖ.

If N<M²: “infinite solution” given by bₖ=(AA^{H})^{t} A Pₖ+(I−(AA^{H})^{t}(AA^{H}))w, where w ∈ [symbol] ^{M2}<′can be any arbitrary vector. So, one can set w=0. Reconstruct Ilk using the obtained bₖ. Use either Case 1 or 2 to find hₖ.

In the rest of this disclosure, “\tilde{ }” is used to highlight the estimated channel values. For example, \tilde{h}ₖ is the estimated value of hₖ obtained via our proposed channel learning mechanism.

FIG. 5 is a flow chart showing a method of wireless power transmission according an embodiment of the present invention. The method 500 shown in FIG. 4 is carried out by the wireless power transmitter 200 shown in FIG. 1 and FIG. 2.

In step 502, the MCU module 250 of the wireless power transmitter 200 estimates spatial channels between the transmitter antennas 210 of the wireless power transmitter and the receiver. The estimation of spatial channels may be carried out according to the method 450 shown in FIG. 4.

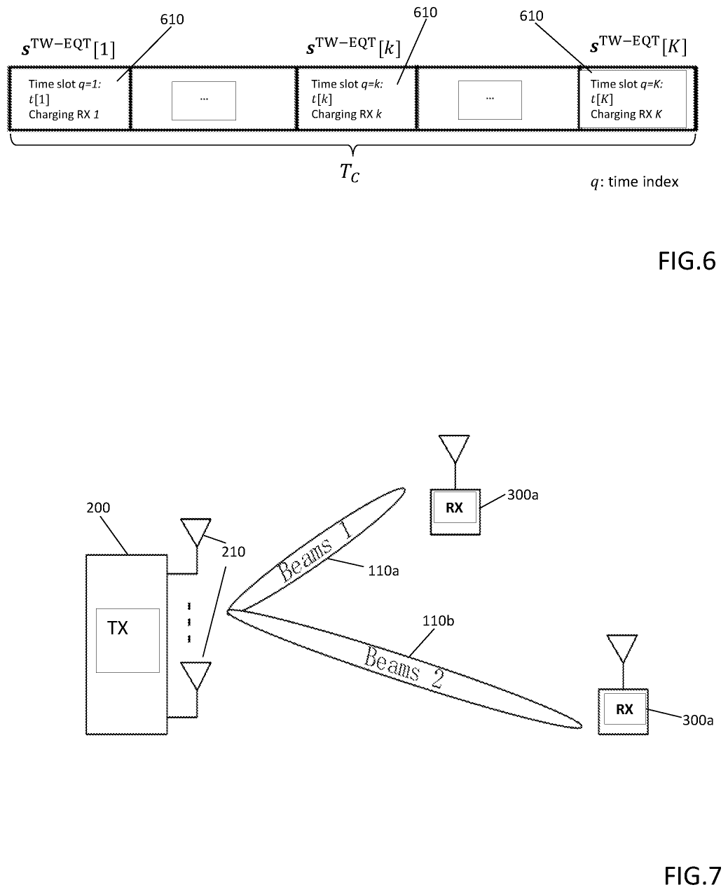

In step 504, the MCU module 250 of the wireless power transmitter 200 divides the transmission time into a plurality of timeslots, with each timeslot being allocated to a respective wireless power receiver. During the timeslot allocated to a respective receiver, the energy storage device of that receiver is charged. The division of the transmission time into a plurality of timeslots is shown in FIG. 6.

FIG. 6 shows the timing structure of an energy transmission phase of wireless power transmission according to an embodiment of the present invention. As shown in FIG. 6, the transmission time T, is divided into divided into K time slots 610. Each of the time slots is allocated to one receiver. In some embodiments each timeslot 610 has an equal duration t[1]==t[K]=T_{c}/K. As described in more detail below, in other embodiments, the duration of the timeslots may vary.

Returning to FIG. 5, in step 506, the MCU module 250 of the wireless power transmitter 200 controls the respective phase shifter modules and power amplifier modules to transmit wireless power signals from the transmitter antennas 210 according to a transmitter signal vector in the respective time slot.

In embodiments in which the timeslots allocated to the respective receivers have equal time duration, the beam calibration algorithm may be termed Time-Switched Transmission, with Equal Time Allocation (TW-EQT).

Under TW-EQT, denote the transmit signal of m-th transmitter antenna at time slot q as Sₘ^{TW-EQT}[q]=αₘ^{TW-EQT}[q]∠φₘₖ^{TW-EQT}[q] One can define and the transmitter signal vector (corresponding to all transmitter antennas) of time slot q as s^{TW-EQT}[q]=[s₁^{TW-EQT}[q] . . . s_{M}^{TW-EQT}[q]]^{T}.

TW-EQT Solution: At time slot q=k, it follows φ^{TW-EQT}ₘ[k]=−∠\tilde{h}ₘₖ and α^{TW-EQT}ₘ[k]=\sqrt{P_{amp,max},} ∀m. This beam particularly maximizes the delivered power to k-th receiver.

If there are constraints on the total transmitter power transmission due to safety regulations, i.e., Σ^{M}ₘ₌₁α²ₘ≤P_{TX,max}, the above solution [only amplitude] is modified as

$${α}_{m}^{TW - EQT} [ k ] = min \{ \vert {\tilde{h}}_{m k} \vert \sqrt{\frac{{P}_{TX , max}}{{\sum }_{m = 1}^{M} {\tilde{h}}_{m k}^{2}}} , \sqrt{{P}_{amp , max}} \}$$

In some embodiments, the duration of the individual timeslots may be varied. The algorithm used in such embodiments may be termed Time-Switched Transmission, with Optimal Time Allocation (TW-OPT). Under TW-OPT, the transmitter signals obtained for TW-EQT is used, but the time allocated to different receivers is optimized as follows.

With the transmitter signals obtained for TW-EQT together with the estimated channel values, the average DC power delivered to k^{th} receiver over all time slots is given by

$${P}_{DC , k}^{TW - EQT} = \frac{1}{{T}_{C}} {\sum }_{q = 1}^{K} t [ q ] {Z}_{k} ( {\vert {\tilde{h}}_{k}^{H} {s}^{TW - EQT} [ q ] \vert}^{2} )$$

where Zₖ (.) is a function mapping the input RF power of the k^{th} receiver's DC-to-RF converter to its output DC power. This function is known to the transmitter.

Optimal Time Allocation for Time-Switched Transmission (TW-OPT) is derived by solving the following Linear Programming (LP):

$$( P 2 ) : {max}_{\{ t [ q ] \}} {min}_{\{ k \}} {P}_{DC , k}^{TW - EQT}$$

$$s . t . {\sum }_{q = 1}^{K} t [ q ] = {T}_{C}$$

One can modify the objective function of (P2) to e.g. maximize the weighted sum of delivered DC power to all receivers. In particular, changing the objective function of (P2) will result in different time allocation solution for TW-OPT.

In the embodiments described above with reference to FIG. 5 and FIG. 6, the timeslots of the transmission period are allocated to respective wireless power receivers. IN alternative embodiments, the beam calibration algorithm executed on the MCU of the wireless power transmitter is configured to optimise beams transmitted to multiple wireless power receivers in a given timeslot. Such a beam calibration algorithm may be termed Beam-Split Transmission (BST).

FIG. 7 is a block diagram illustrating split beam wireless power transmission according to an embodiment of the present invention. As shown in FIG. 7, during one timeslot, the amplitude and the phase of the signals generated by the transmitter antennas 210 of the wireless power transmitter 200 are controlled to generate multiple beams 110a 110b to transmit power to multiple receivers 300a 300b within the same timeslot.

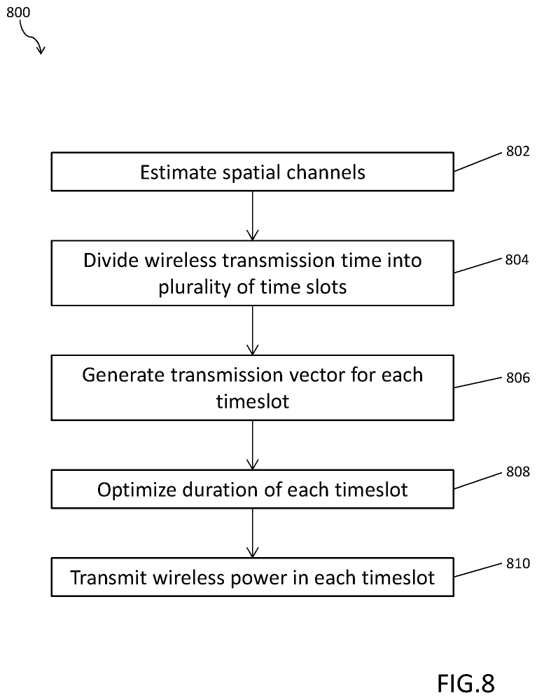

FIG. 8 is a flow chart showing a method of split beam wireless power transmission according to an embodiment of the present invention. The method 800 shown in FIG. 8 is carried out by the wireless power transmitter 200 shown in FIG. 1 and FIG. 2.

In step 802, the MCU module 250 of the wireless power transmitter 200 estimates spatial channels between the transmitter antennas 210 of the wireless power transmitter and the receiver. The estimation of spatial channels may be carried out according to the method 450 shown in FIG. 4.

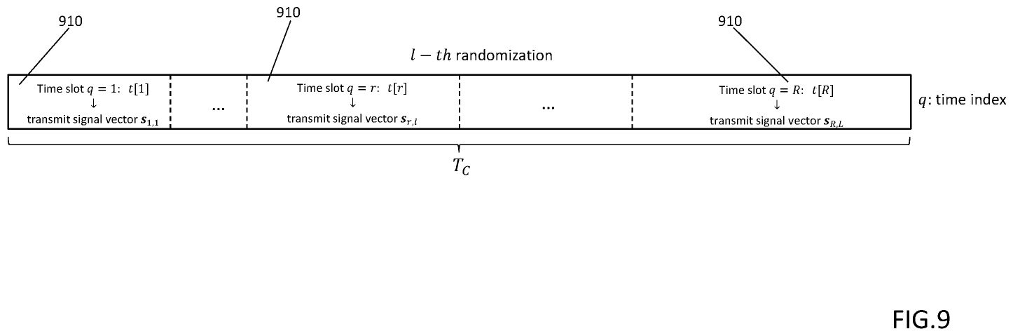

In step 804, the MCU module 250 of the wireless power transmitter 200 divides the transmission time into a plurality of timeslots. An example of a transmission time divided into a plurality of timeslots is shown in FIG. 9.

FIG. 9 shows the timing structure of an energy transmission phase of split beam wireless power transmission according to an embodiment of the present invention. As shown in FIG. 9, the transmission time Tc is divided into divided into R time slots 910.

Returning now to FIG. 8, in step 808, the MCU module 250 of the wireless power transmitter 200 generates a transmission vector for each time slot.

The basis for the solution is S.

Define R=rank(S*)>1.

Define Sᵣ=P_{amp,max} uᵣuᵣ^{H}, where uᵣ is the r-th eigenvector of S* with R ∈ {1, . . . , R}.

Sᵣ's may not satisfy the maximum RF power amplifier power constraint. Thus, randomization technique is used to modify Sᵣ's such that the amplifier constraint holds.

Next, time switching is used to implement modified Sᵣ's, where the duration of time allocated to each Sᵣ is then optimized. An example of this is shown in FIG. 9.

Generate L≥1 independent realizations from the population of Circularly Symmetric Complex Gaussian (CSCG) vectors.

Let û_{r,l}= [symbol] [symbol] (0, Sᵣ) denote the l-th randomization. Normalize it as ũ_{r,l}=(û_{r,l}[n]./|û_{r,l}[n]|)^{H}, where “./” is the element-wise divider operator.

Modify S_{r,l}=P_{amp,max} ũ_{r,l} u_{r,l}^{H}, which satisfies the maximum amplifier constraint.

The transmit signal vector corresponding to the r-th eigenvector at l-th randomization is s_{r,l}=\sqrt{P_{amp,max}} ũ_{r,l}.

Next steps: Optimizing the time allocations t[q], Vg for each individual randomization; and then choosing the best randomization.

In step 808, the MCU module 250 of the wireless power transmitter 200 optimizes the duration of each timeslot.

Under l-th randomization, the average power delivered to RX k over all time slots is estimated by

$${P}_{DC , k}^{R N {D}_{l}} = \frac{1}{{T}_{C}} {\sum }_{q = 1}^{R} t [ q ] {Z}_{k} ( {\vert {\tilde{h}}_{k}^{H} {s}_{q , l} \vert}^{2} )$$

Optimal time allocation at l-th randomization is derived by solving the following LP:

$$( P 4 - l ) : {max}_{\{ t [ q ] \}} {min}_{\{ k \}} {P}_{DC , k}^{R N {D}_{l}}$$

$$s . t . {\sum }_{q = 1}^{R} t [ q ] = {T}_{C}$$

Let denote the objective value of (P4-l).

Best Realization, denoted by l*, is derived as

$${l}^{⋆} = arg {max}_{\{ l \}} {P}_{DC , min}^{{RND}_{l}} .$$

Solution for Practical Implementation of BST: one can implement the sequence of transmitter signal vectors s_{r,l*}, r=1, . . . ,R with the optimal time allocation obtained from (P4-l*).

In step 810, the MCU 250 of the wireless power transmitter 200 controls the respective phase shifter modules and power amplifier modules to transmit wireless power signals from the transmitter antennas 210 according to a transmitter signal vector in the respective time slot.

In some embodiments, the channel learning phase 420 shown in FIG. 3 takes place in each frame 410 of the wireless power transmission. However, in other embodiments, the transmission of the pilot sequence is adapted depending on changes in the received wireless power detected during the energy transmission phase 430.

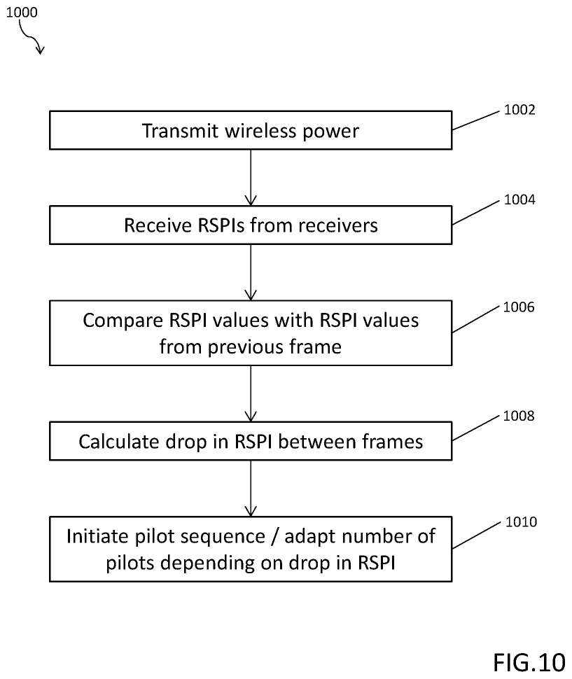

FIG. 10 is a flow chart showing a method of adapting pilot sequence transmission according to an embodiment of the present invention. The method 1000 shown in FIG. 10 is implemented on the MCU module 250 of the wireless power transmitter 200.

In step 1002, the MCU module 250 of the wireless power transmitter 200 controls power transmission by the wireless power transmitter 200. During the power transmission, the wireless power receivers 300 monitor the received power and provide received signal power indicators (RSPI)s over the wireless data channel 130.

In step 1004, the MCU module 250 of the wireless power transmitter 200 receives the RSPIs from the wireless power receivers 300.

In step 1006, the MCU module 250 of the wireless power transmitter 200 compares the received RSPIs for the current frame with values stored from a previous frame.

In step 1008, the MCU module 250 of the wireless power transmitter 200 calculates a drop in RSPI between frames. This drop may be calculated for each wireless power receiver and the following analysis may be carried out based on largest drop in RSPI. Based on the calculated drop in RSPI, the MCU module 250 determines whether to include a pilot sequence in the next frame. The MCU module 250 may compare the drop in RSPI with a threshold, and if the drop in RSPI is greater than the threshold which may be, for example 20%, then a pilot sequence is included in the next frame. If the drop in RSPI is less than the threshold then the pilot signal is omitted from the next frame and thus the next frame includes only a power transmission phase. Thus, a greater proportion of the time is spent on power transmission.

In some embodiments, the number of pilot signals is adapted depending on the drop in RSPI. For example, if the drop in RSPI is greater than a first threshold, for example a 20% drop in RSPI, but less than a second threshold, for example a 70% drop in then a reduced number of pilot signals are used, and it if the drop is greater than the second threshold, then the full number of pilot signals are used. The number of pilot signals may be determined as a function of the drop RSPI such that when there is a large drop a larger number of pilot signals are sent and when there is a small drop in RSPI a smaller number of pilot signals are sent. Also, the previous/outdated channel information may be used to generate random pilot signals around them if the RSPI drop is within an acceptable range of e.g. 20% to 40%.

Whilst the foregoing description has described exemplary embodiments, it will be understood by those skilled in the art that many variations of the embodiments can be made within the scope and spirit of the present invention.

1. A method of learning channels between a transmitter and a plurality of receivers in a wireless power network, the transmitter comprising an array of wireless power transmission antennas, the method comprising:
transmitting a pilot signal from the wireless power transmission antennas of the transmitter;
receiving feedback signals from each receiver of the plurality of receivers, the feedback signals comprising received signal power indications for each respective receiver;
calculating channel matrices for channels between the wireless transmission antennas and wireless power reception antennas of each receiver by minimizing an objective function of a channel matrix and the received signal power indications for the respective receiver; and
estimating spatial channel signatures of the reception antennas on the array of wireless power transmission antennas from the dominant eigenvalue and corresponding eigenvector of the respective channel matrix.

2. A method according to claim 1, wherein the objective function is the sum squared difference between the estimated power delivered to each respective receiver calculated using the channel matrix and the received signal power indications for each respective receiver.

3. A wireless power transmission method in a wireless power network, the wireless power network comprising a wireless power transmitter and a plurality of wireless power receivers, the wireless power transmitter comprising an array of wireless power transmission antennas and each wireless receiver of the plurality of wireless power receiver comprising a wireless power reception antenna, the method comprising:
estimating spatial channels between the array of wireless power transmission antennas and the wireless power reception antennas of the plurality of wireless power receivers;
dividing a wireless power transmission time into a plurality of timeslots, wherein each timeslot is allocated to a respective one of the wireless power receivers; and
in each timeslot of the plurality of timeslots, transmitting power from the array of wireless power transmission antennas according to a transmitter signal vector that maximizes the delivered power to the wireless power receiver to which the timeslot is allocated.

4. A method according to claim 3, wherein the amplitude of the power transmitted from the array of wireless power transmission antennas is modified according to a total power transmission constraint.

5. A method according to claim 3, wherein each timeslot has an equal duration.

6. A method according to claim 3, further comprising optimizing the duration of each respective timeslot.

7. A wireless power transmission method in a wireless power network, the wireless power network comprising a wireless power transmitter and a plurality of wireless power receivers, the wireless power transmitter comprising an array of wireless power transmission antennas and each wireless receiver of the plurality of wireless power receivers comprising a wireless power reception antenna, the method comprising:
estimating spatial channels between the array of wireless power transmission antennas and the wireless power reception antennas of the plurality of wireless power receivers; and
dividing a wireless power transmission time into a plurality of timeslots;
in each timeslot of the plurality of timeslots, transmitting power from the array of wireless power transmission antennas according to a transmitter signal vector, wherein the duration of respective timeslots is optimized according to a target constraint on the power delivered to each respective antenna over the plurality of timeslots.

8. (canceled)

9. A wireless power transmission method in a wireless power network, the wireless power network comprising a wireless power transmitter and a plurality of wireless power receivers, the wireless power transmitter comprising an array of wireless power transmission antennas and each wireless receiver of the plurality of wireless power receivers comprising a wireless power reception antenna, the method comprising:
transmitting wireless power from the array of wireless power transmission antennas;
receiving an indication from a wireless receiver of the plurality of wireless power receivers, the indication indicating a signal power received by the wireless receiver during the wireless power transmission;
comparing the signal power received by the wireless receiver during the wireless power transmission with a signal power received by the wireless receiver during a previous frame of wireless power transmission to determine a drop in signal power received by the wireless receiver; and
if the drop in signal power received by the wireless receiver exceeds a threshold initiating a channel learning sequence in a succeeding frame of wireless power transmission.

10. A method according to claim 9, wherein further comprising determining a number of pilot signals for the channel learning sequence based on the drop in signal power received by the wireless receiver.

11. (canceled)

12. A controller for a wireless power transmitter configured to cause the wireless power transmitter to carry out a method according to claim 1.

13. A non-transitory computer readable carrier medium carrying processor executable instructions which when executed on a processor cause the processor to carry out a method according to claim 1.

14. A wireless power transmitter comprising an array of wireless power transmission antennas and a controller configured to:
control the transmission antennas to transmit a pilot signal;
receive feedback signals from each receiver of a plurality of receivers, the feedback signals comprising received signal power indications for each respective receiver;
derive channel matrices for channels between the wireless transmission antennas and wireless power reception antennas of each respective receiver by minimizing an objective function of a channel matrix and the received signal power indications for the respective receiver; and
estimate spatial channel signatures of the reception antennas on the array of wireless power transmission antennas from the dominant eigenvalue and corresponding eigenvector of the respective channel matrix.

15. A wireless power transmitter according to claim 14, wherein the objective function is the sum squared difference between the estimated power delivered to each respective receiver calculated using the channel matrix and the received signal power indications for each respective receiver.

16. A wireless power transmitter according to claim 14, wherein the controller is further configured to:
divide a wireless power transmission time into a plurality of timeslots, wherein each timeslot is allocated to a respective one of the wireless power receivers; and
in each timeslot of the plurality of timeslots, control the array of wireless power transmission antennas to transmit power according to a transmitter signal vector that maximizes the delivered power to the wireless power receiver to which the timeslot is allocated.

17. A wireless power transmitter according to claim 16, wherein the controller is configured to control the amplitude of the power transmitted from the array of wireless power transmission antennas according to a total power transmission constraint.

18. A wireless power transmitter according to claim 16, wherein each timeslot has an equal duration.

19. A wireless power transmitter according to claim 16, wherein the controller is further configured to optimize the duration of each respective timeslot.

20. A wireless power transmitter according to claim 14, wherein the controller is further configured to:
estimate spatial channels between the array of wireless power transmission antennas and wireless power reception antennas of a plurality of wireless power receivers; and
divide a wireless power transmission time into a plurality of timeslots; and
in each timeslot of the plurality of timeslots, transmit power from the array of wireless power transmission antennas according to a transmitter signal vector, wherein the duration of respective timeslots is optimized according to a target constraint on the power delivered to each respective antenna over the plurality of timeslots.

21. A wireless power transmitter according to any claim 16, wherein the controller is further configured to:
control the transmission antennas to transmit a pilot signal;
receive feedback signals from each receiver of a plurality of receivers, the feedback signals comprising received signal power indications for each respective receiver;
derive channel matrices for channels between the wireless transmission antennas and wireless power reception antennas of each respective receiver by minimizing an objective function of a channel matrix and the received signal power indications for the respective receiver; and
estimate spatial channel signatures of the reception antennas on the array of wireless power transmission antennas from the dominant eigenvalue and corresponding eigenvector of the respective channel matrix.

22-24. (canceled)
